(19) United States
(12) Patent Application Publication
(10) Pub. No.: US 2005/0085369 A1
(43) Pub. Date: Apr. 21, 2005

(54) Fibres and their production

(76) Inventor: Soren L Jensen, Kobenhavn (DK)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/497,707

(22) PCT Filed: Dec. 10, 2002
(86) PCT No.: PCT/EP02/13988

(30) Foreign Application Priority Data
Dec. 12, 2001 (EP) 01310388.2

(51) Int. Cl. C03C 13/00; C03C 13/06

(52) U.S. Cl. 501/35; 65/476; 65/468; 65/465; 501/36

(57) ABSTRACT

Continous glass filaments, and fibres obtained by comminuting the filaments and microfibres obtained by flame attenuation of the filaments, are formed of a substantially colourless aluminosilicate glass containing 25 to 52% SiO₂, 20 to 35% AL₂O₃ and 0 to 1.5% FeO and having good biosolubility.

This invention relates to novel fibres and their production wherein the fibres are continuous glass filaments or, in particular, are chopped fibres (made by chopping continuous glass filaments or products containing them) or microfibres (namely the fibres obtained by flame attenuation of continuous filaments.

Fibres of these general types (but having different compositions and properties from those of the invention) are typified by the various forms of E-glass fibre. These are made as continuous filaments by forming a melt from a homogeneous charge (usually of marbles) in a melter which is heated by gas and/or oil and/or electricity, flowing the melt through a forehearth into a bushing containing a plurality of extrusion orifices for the melt, and mechanically drawing filaments downwardly from the orifices and collecting them as solid endless filaments, usually in the form of a bundle.

These filaments, alone or with other filaments, may be used to form fabrics or other sheet materials.

They (or yarns containing them) may be comminuted by any suitable cutting operation so as to provide cut fibres, typically 3 to 25 mm long, which may be used for, for instance, forming non-woven fabrics of or containing the chopped fibres, alone or with other fibres.

The initial filaments, or bundles of filaments, may be formed as a rather coarse filament or bundle of filament and then subjected to flame attenuation. This process results in remelting the solidified filaments or bundle by applying a high temperature gas flame, normally substantially at right-angles to the filament or bundle, under conditions whereby the primary filament or bundle melts and is attenuated into many fine relatively short fibres. These fibres are carried by the high velocity gases originating from the flame through a duct and are collected as a web, and optionally sprayed with binder. Flame attenuation can produce fibres which are referred to as microfibres (or ultra fine fibres). These flame-attenuated fibres are usually finer and shorter than the cut fibres made by cut filaments and they have a wider spread of fibre diameters and lengths.

Continuous filaments are non-respirable and therefore may not provide a health concern while they are in the form of continuous filaments. However there is a concern when they break and, especially, continuous fibres that are chopped, crushed or otherwise processed during manufacture or use may contain small amounts of respirable fibre-like fragments of the same composition. Similarly, microfibres may be respirable or may include respirable fragments. Products containing any of these fibres (for instance as reinforcement) may be abraded during use, or may be cut when being prepared for use, to cause the escape of glass dust.

E-glass fibres are durable, and respirable E-glass fibres have been shown to cause advanced fibrosis, lung cancer and mesothelioma in animal studies. In the evaluation of IARC (International Agency for Research on Cancer) from October 2001 it is concluded, that “there is sufficient evidence in experimental animals for the carcinogenicity of special purpose glass fibres including E-glass and 475 glass fibres”.

It would therefore clearly be desirable to be able to produce drawn glass filaments (and chopped fibres and microfibres obtained from them) which can be shown to have good biosolubility. It would then be possible to use such filaments and fibres for uses where a showing of biosolubility is necessary or desirable. The filaments and fibres can also be used as replacements for conventional filaments and fibres (e.g., traditional E-glass) where a showing of biosolubility is not required.

Various compositions have been proposed for glass filaments and so it will be found that there are numerous references in the literature to wide ranges of compositions theoretically being converted into continuous glass filaments. The technical reality, however, is that compositions which are actually going to be converted into filaments on a commercial scale by a convenient apparatus have very narrowly defined properties, including especially purity and colour, and so in practice filaments are actually made only from a small number of classes of compositions.

For a detailed discussion of compositions suitable for manufacturing continuous glass filaments, including chopped fibres and microfibres obtained from them, and of processes and apparatus for making the filaments, reference should be made to “The Manufacturing Technology of Continuous Glass Fibres”, Third Edition, by Loewenstein, published Elsevier 1993, especially pages 26 to 131 (referred to below as “Loewenstein”).

Loewenstein shows in table 4.2 typical compositions of the glasses of greatest commercial interest, these compositions being, expressed as % by weight of oxides, E glass C glass A glass S glass R glass

| | E glass | C glass | A glass | S glass | R glass |
|---|---|---|---|---|---|
| SiO₂ | 55.2 | 65 | 71.8 | 65.0 | 60 |
| Al₂O₃ | 14.8 | 4 | 1.0 | 25.0 | 25 |
| B₂O₃ | 7.3 | 5 | — | — | — |
| TiO₂ | 0 | — | — | — | — |
| MgO | 3.3 | 3 | 3.8 | 10.0 | 6 |
| CaO | 18.7 | 14 | 8.8 | — | 9 |
| Na₂O + K₂O | 0.5 | 8.5 | 13.6 | — | — |
| Fe₂O₃ | 0.3 | 0.3 | 0.5 | trace | — |
| F₂ | 0.3 | — | — | — | — |

Of these, E glass is the glass which is predominantly used for glass filaments, and cut fibres and microfibres obtained from them.

Loewenstein also mentions others glasses, including a dielectric glass containing 45 to 65% SiO₂, 9 to 20% Al₂O₃, 13 to 30% B₂O₃ and 4 to 10% CaO+MgO+ZnO (table 4.3).

The efficiency with which the melt can be formed, and maintained in the molten state, in the furnace is greatly reduced if the melt is not substantially colourless. This is because increasing the colour of the melt greatly reduces the transmission of heat energy through the melt with the result that heating of the melt is much less uniform and so operation of the process is much more difficult unless the furnace is designed specifically, and in a less efficient manner, to allow for the inferior heating of the melt. For instance a process specifically intended to operate with a coloured melt is described in U.S. Pat. No. 6,125,660.

Accordingly, although it is theoretically possible to form a coloured melt and then to form continuous glass filaments from it by extrusion and mechanical drawing from the orifices of a bushing leading from the forehearth of a furnace, performance of the process is much more efficient if the melt is substantially colourless. As a result the production of continuous filaments (and chopped fibres and microfibres derived from them) of coloured glasses containing these higher amounts of iron is probably, at most, a few hundred tons per annum compared to the hundreds of thousands of tons per annum worldwide for continuous fibres of substantially colourless glasses such as those listed above in Loewenstein.

Glasses and other vitreous melts containing iron oxide can, however, easily be formed using other melting apparatus, such as a cupola furnace. The melt cannot be fiberised by extrusion and drawing but it can be fiberised into wool by centrifugal fiberisation techniques. One such technique involves the spinning cup. Another involves cascade spinners, in which the melt is poured on to the outer surface of one or more substantially cylindrical rotors which spin about a substantially horizontal axis, whereby fibres are thrown off the surfaces and collected as wool.

These centrifugal fiberisation techniques are used for products which are generally known as stone, rock or slag wool, but can also be used for glass wool. The melt for this technique is usually relatively crude and dark and can even contain a few minor undissolved particles or other non-melt components. These are acceptable in wool made by centrifugal fiberisation because the worst that these can do to the fiberising process is to increase the amount of shot or waste material which is made on the centrifugal fiberiser. Similarly, iron is acceptable in melts which may be regarded as being glass melts but which are to be centrifugally fiberised.

The inclusion of iron oxide in the melt (thereby causing the melt to be dark) modifies the melt properties, (which are then suitable for centrifugal fiberisation), allows cheaper raw materials to be used and improves the resistance of the fibres to high temperatures. Typically the fibres contain 2 to 10%, often around 4 to 10% iron (measured as FeO).

There have been many proposals to improve the biosolubility of these iron-containing stone, rock or slag fibres which are made by centrifugal fiberisation. Some of the proposals concentrated on solubility of these very fine rock, stone or slag fibres at around pH 7.5 (for instance WO87/05007, WO89/12032, EP-A-459,897, WO92/09536, WO93/22251 and WO94/14717). Others concentrated on solubility at around pH 4.5 (for instance WO96/14274, WO97/30002, WO97/31870 and WO99/56526). An early discussion of solubilities at both around pH 4.5 and around 7.5 was by Christensen et al in Environmental. Health Perspectives Volume 102, Supplement 5, October 1994 pages 93 to 96. There have been numerous other publications on biosolubility of rock, stone or slag wool but it is believed they do not add significantly to the generality of what is established by those listed above.

However the manufacturing constraints, including the requirement that the melt should be colourless and should have a temperature-viscosity profile suitable for extrusion and mechanical drawing are such that none of these melts can be used to provide continuous glass filaments (and chopped fibres and microfibres) in an economical manner for those uses where it is required that they should be shown to have good biosolubility.

Where attempts have been made to provide improved biosolubility in glass fibres, these attempts have usually involved reducing the amount of alumina generally to very low values, and optionally adding phosphorous and/or increasing the amount of alkali, for instance as described in EP-A-412,878. Biosoluble glass fibres can therefore be made, but it is difficult to form drawn continuous filaments and chopped fibres and microfibres in an economic manner from such melts.

It would therefore be desirable to be able to provide colourless, drawn, continuous glass filaments (and chopped fibres and microfibres obtained from them) which can be shown to have satisfactory biosolubility and which can be made from a substantially colourless melt by convenient extrusion and drawing processes and apparatus. The process and apparatus would preferably be as close as possible to the conventional E-glass processes and apparatus, and with, for instance, only small changes in the alloys used for defining the extrusion orifices, if necessary).

In the invention we provide fibres of substantially colourless aluminosilicate glass containing, by weight oxides,

| | |
|---|---|
| SiO₂ | 25-52% |
| Al₂O₃ | 20-35% |
| SiO₂ + Al₂O₃ | 60-80% |
| FeO | 0-1.5% |
| CaO | 5-30% |
| MgO | 0-20% |
| Na₂O + K₂O | 0-15% |
| B₂O₃ | 0-10% |
| TiO₂ | 0-5% |

In one preferred embodiment, B₂O₃ is present in an amount of 0.5 or 1-10%, often 2-10% and preferably 5-10% and most preferably 7-10%. In this embodiment, the amount of Na₂O+K₂O is usually below 5% and preferably below 2% and most preferably zero or below 0.5%.

In another preferred embodiment the amount of B₂O₃ is below 2%, and usually zero or below 0.5% or 1%, and the amount of alkali is above 2%, often 3 to 12% and most preferably 5 to 10%.

The glass is preferably a peralkaline aluminosilicate glass. By this we mean that the mole percentage MgO+CaO+FeO+Na₂O+K₂O is greater than or equal to the mole percentage of Al₂O₃.

Throughout this specification, all amounts are expressed as percentages by weight calculated on the weight of oxides in the glass (which is identical with the melt). Iron is expressed as FeO even though some or all of it may be present in the glass as trivalent iron. All percentages expressed as a whole number should be interpreted as meaning the exact whole number, so that 50% means 50.0%.

The elements quantified and listed above preferably provide at least. 90% and usually at least 95% and preferably at least 98% (by weight of the oxides) of the glass, and often they provide 100% of the glass. There can be trace amounts of other elements and there can be deliberate additions of other elements (up to 100%), provided this does not deleteriously influence the properties of the glass. Such other elements which may be included are, for instance, BaO, ZrO₂, Li₂O, F₂, ZnO, and P₂O₅. Usually the maximum amount (as oxide) of any element other than those quantified above is below 2% and usually not more than 1%, by weight oxides. The optional ingredients generally do not include Y₂O₃, La₂O₃ or CeO₂.

Although the amount TiO₂ may be zero or low (for instance below 3%) it is often desirable to include one, two or three (or more) oxides selected from TiO₂, ZrO₂, BaO, ZnO and Li₂O generally in a total amount of 2-10%, each generally being in an amount of 0.1 to 5%, often 1 to 3%., in order to adjust melt properties, especially the liquidus temperature. The addition of BaO, for instance, in an amount of at 0.5 to 5%, (and optionally with TiO₂ and/or ZrO₂) can be particularly useful. This applies both with fibres containing 2-10% B₂O₃ and with the low or zero B₂O₃ fibres described above. These additions improve the mechanical properties of the fibres and influence the liquidus temperature and viscosity profile.

In all the fibres of the invention, the amount of FeO is usually below, or not more than, 1.0% and preferably not more than 0.5%. Often it is not more than 0.3%. It may be zero.

The amount of SiO₂ is usually not more than 0.50% and often not more than 48%. It is usually at least 35 or 40%, and often is at least 43% or 45%.

The amount of SiO₂+Al₂O₃ is usually not more than 78% and preferably not more than 75%. Often it is at last 60% and is preferably at least 63% or 65%.

The amount of CaO is usually at least 10%. Often it is not more than 22%, frequently not more than 20%.

The amount of MgO is usually at least 2%. Often it is not more than 12% and preferably not more than 10%. Often it is not more than 8% and prefearbly it is not more than 6%.

The amount of CaO+MgO is often at least 15% but below 25%. The amount of CaO, by weight, is usually at least twice the amount of MgO.

The amount of Na₂O+K₂O is often at least 2%, and often at least 3.5% and usually at 5%, but preferably not more than 10%. However, as explained above, the amount of alkali is often at or near zero when the fibres contain at least 2% B₂O₃.

The amount of TiO₂ is usually not more than 3% and often not more than 1%, and often it is below 0.5%, typically zero.

Depending upon the predominant criteria (for instance optimum manufacturing conditions or intended biosolubility or other properties of the final products) the fibres of the invention tend to fall into five classes.

One class in the B₂O₃-containing fibres which contain little or no alkali as discussed above (referred to below as class A fibres).

A second class is the alkali-containing fibres which contain little or no B₂O₃, as discussed above. (referred to below as class B fibres).

A third class of fibres are referred to as class C fibres and contain

| | |
|---|---|
| SiO₂ | 43-52% |
| Al₂O₃ | 25-35% |
| SiO₂ + Al₂O₃ | 70-80% |
| FeO | 0-1.5% |
| CaO | 5-30% |
| MgO | 0-20% |
| B₂O₃ | 0-10% |
| Na₂O + K₂O | 0-15% |
| TiO₂ | 0-5% |

Within these class C fibres, iron, calcium, magnesium, alkali and titania (and boron, if present) are preferably all as discussed above, and these elements preferably provide at least 95%, and often 98 or 100%, of the glass.

The amount of SiO₂ is preferably not more than 50% and most preferably not more than 48%. Usually it is at least 44% or 45% and preferably at least 46%. The amount of Al₂O₃ is generally at least 26.5% or 27%. Instead of or in addition to selecting SiO₂ and/or Al₂O₃ within these preferred ranges, preferably the amount of SiO₂+Al₂O₃ in these class C fibres is at least 72 or 73% and often below 78% or 75%.

A fourth class of fibres, which may be boron-free or boron-containing, are referred to as class D fibres and contain

| | |
|---|---|
| SiO₂ | 35-45% |
| Al₂O₃ | 20-30% |
| SiO₂ + Al₂O₃ | 60-75% |
| FeO | 0-1.5% |
| CaO | 5-30% |
| MgO | 0-20% |
| B₂O₃ | 0-10% |
| Na₂O + K₂O | 0-15% |
| TiO₂ | 0-5% |

In these class D fibres the amount of SiO₂ is often at least 38% and generally at least 40%. The amount of SiO₂ is often not more than 44%, preferably not more than 42%. The amount of Al₂O₃ is generally at least 22% and preferably at least 23%. The amount of SiO₂+Al₂O₃ is generally at least 65% and preferably at least 67 or 68% but often not more than about 72%. The quantified elements (including boron if present) generally provide at least 95%, and often 98-100% of the glass, as discussed above.

A fifth class of fibres within the invention are is boron-free or boron-containing fibres and are referred to as class E fibres and contain

| | |
|---|---|
| SiO₂ | 30-40% |
| Al₂O₃ | 25-35% |
| SiO₂ + Al₂O₃ | 60-75% |
| FeO | 0-1.5% |
| CaO | 5-30% |
| MgO | 0-20% |
| B₂O₃ | 0-10% |
| Na₂O + K₂O | 0-15% |
| TiO₂ | 0-5% |

Each of classes C, D and E can be sub-divided into preferred fibres which contain B₂O₃ but little or no alkali, and preferred fibres which contain alkali but little or no B₂O₃, as discussed above.

The inclusion of BaO and/or TiO₂ and/or ZrO₂ can be advantageous for each class, as discussed above.

The class C fibres are particularly valuable because of the biosolubility and their mechanical properties and their viscosity-temperature profile. They can generally be produced easily by extrusion at a relatively high temperature and high viscosity.

The class D fibres have particularly good biosolubility and mechanical properties and are best manufactured at lower process temperatures and lower viscosities.

The class E fibres are of particular value for specialised applications. Again they have good biosolubility.

Substantially all fibres within each of these classes have good biosolubility and this can be confirmed by subjecting the fibres to a biosolubility test (as discussed below).

The various fibres defined above are preferably made by extrusion and mechanical drawing (in contrast to centrifugal extrusion) in a manner similar to conventional E glass manufacture. Preferred fibres are microfibres as discussed above, cut fibres made by cutting continuous filaments into staple fibres, and the continuous filaments. The invention also includes products which consist of or are reinforced by filaments or cut fibres or microfibres made from such filaments and which are liable to be cut or abraded during installation, manufacture or use, with possible release of glass dust.

In this specification, references to biosolubiilty are particularly related to in-vivo biopersistence as measured according to the EU-guidelines (European Commission. (1997).a) Biopersistence of fibres. Intratracheal Instillation. ECB/TM/17[rev.7], Directorate General, Joint Research Centre. B). Biopersistence of fibres. Short-term exposure by inhalation. ECB/TM/26[rev.7], Directorate General, Joint Research Centre). In these tests rats are exposed to fibres, size-selected to be rat-respirable and the elimination of fibres from the rat lungs is followed with time. As a result the biosolubiilty or the biopersistence is described by the half-time, T₅₀. The fibres in this invention will typically have a half-time for elimination of long fibres (>20 μm) after inhalation of less than 20 days, preferably less than 15 days and most preferable less than 10 days. The fibres in this invention will typically have a half-time for elimination of long fibres (>20 μm) and/or of WHO fibres (defined as fibres having a diameter <=3 μm, a length >5 μm and a length to width ration of >=3:1) after intratracheal instillation of less than 80 days, preferably less than 60 days and most preferably less than 40 days. IARC (October 2001) concluded that “a number of studies in rates have suggested a correlation between the biopersistence of long fibres (>20 μm) and their pathogenicity with respect to lung fibrosis and thoracic tumours”.

Biosolubility may also be assessed measuring the in-vitro dissolution rate, e.g., such as described in [European Insulation Manufacturers' Association (EURIMA). (1998). Test guideline for “In-vitro acellular dissolution of man-made vitreous silicate fibers (pH 7.4 and pH 4.5)”, Draft 11]¹. IARC (October 2001) conclude that “the most informative studies employ flow-through systems using balanced salt solutions at physiological pHs likely to be encountered in the intrapulmonary environment. The results from such studies have shown correlations with rates of removal of long fibres from the lung in short-term biopersistence assays”.

The fibres in the present invention preferably have in-vitro dissolution rates at pH 4.5 measured in a flow-through set up as described in [European Insulation Manufacturers' Association (EURIMA). (1998). Test guideline for “In-vitro acellular dissolution of man-made vitreous silicate fibers (pH 7.4 and pH 4.5)”, Draft 11] of at least 200 ng/cm²h, preferably at least 300 ng/cm²h, and most preferably at least 400 ng/cm²h.

The glasses have a tetrahedral structure formed predominantly by silicon and aluminium with atoms bridged by oxygen atoms. A preferred class of fibres according to the invention are free of boron or contain less than 2% B₂O₃ and the amount of SiOSi bridges in the glass is not more than 18% and preferably not more than 17%, and generally not more than 15% (but usually above 10 or 12%), when calculated by the protocol defined below. Fibres having this number of SiOSi bridges (or less) have particularly good biosolubility.

Varying the proportions of the elements will influence the calculated SiOSi value and the T_{liq} and the temperature-viscosity curve. The common general knowledge of the effect of compositional changes on T_{liq} and the temperature viscosity curve, and the teachings below about the calculation of SiOSi linkages, will allow appropriate selection of the content of the materials.

SiO₂ must be at least 25% and is often above 30% and usually above 35 or 40%. It must not be above about 50% and often it is below 48%. Reducing the amount of SiO₂ tends to decrease the calculated SiOSi value and decrease the viscosity at any specific temperature whilst increasing SiO₂ has the opposite effect.

The amount of Al₂O₃ must be at least 20% and is often at least 23% and usually at least 25%. It must be not more than 35% and is often below 32% and usually below 30%. Reducing the amount of Al₂O₃ tends to increase the calculated SiOSi value and decrease the viscosity at any specific temperature whilst increasing Al₂O₃ has the opposite effect.

The amount of CaO must be at least 5% and is often at least 10%. It must be below 30% and is often below 25% and usually below 20%. MgO is optional but is often present in an amount of at least 2% usually at least 5%. It must be below 20% and is often below 10%. To some extent CaO and. MgO can be considered together and are generally present in an amount of 10 to 40%, often 10 to 25%. In general, reducing them individually or together tends to increase the calculated SiOSi value and increase the viscosity at any specific temperature whilst increasing them has the opposite effect.

Na₂O+K₂O can be considered together and the combined amount is usually at least 0.5%, or 2% and is often at least 3%. It must not be above 15% and is often below 12% and usually below 10%. Usually the amount of Na₂O is 5 to 10%. Reducing Na₂O+K₂O tends to increase the calculated SiOSi value whilst increasing them has the opposite effect. When B₂O₃ is present, the amount of alkali may be low or zero.

The amount of FeO is critical and must be below 1.5% and is usually below 1.0%. Preferably it is below 0.7%.

A very small amount of iron is often convenient (because it allows the use of raw materials which have trace iron content) and may improve performance due to the effect it has on radiation properties during melting. Accordingly, although the amount of iron can be zero or trace, usually it is at least 0.1% and is typically in the range 0.2 to 0.5%.

Since it is desirable that the fibres can be made using furnaces and extrusion techniques substantially the same as those which are conventional for E-glass manufacture, the melt preferably has an appropriate viscosity-temperature relationship and this is conveniently discussed by reference to the liquidus temperature, T_{liq}.

Protocols for determining T_{liq}, viscosity and other temperatures are given below.

The viscosity at T_{liq} is preferably at least 300 poise and preferably at least 500 poise and most preferably at least 900 or 1000 poise. Preferably viscosity at T_{liq} is at least 1020 poise, often at least 1050 poise and preferably at least 1100 poise. It is not necessary for it to be very much higher than this and so it is usually below 10000 poise, preferably below 5000 poise and values below 2000 poise, and often below 1500 poise, are often preferred.

An alternative way of indicating that the viscosity at T_{liq} is at the chosen viscosity (e.g., 900 poise) is to indicate that the temperature at which the viscosity is 900 poise is at least T_{liq}, and preferably is above T_{liq} by at least 5° C. and usually at least 10 or 20° C. up to 50° C. or more. It is usually unnecessary for it to be more than 100° C. or 150° C. above T_{liq}.

When the fibres are to be continuous filaments, it is preferred that the viscosity at T_{liq} should be at least 900 poise, but lower viscosities are suitable for the manufacture of microfibres.

The temperature of the melt for extrusion is preferably above T_{liq} in order to minimise or avoid incipient crystallisation in the melt or filaments before or during extrusion. Accordingly the melt being extruded normally has a temperature at least 30° C. above T_{liq} and often at least 50° C. above T_{liq}. Thus the melt temperature is usually at least T_{liq}+50 during extrusion.

A preferred additional feature, which is a particular benefit of the class A fibres, is that the melt is what is frequently referred to as a “strong” melt and therefore crystallises very slowly and so will stay molten during extrusion even after the temperature of the extruded melt has dropped below T_{liq}, the liquidus temperature.

The difference in heat capacity between the glass and the melt at Tg is therefore preferably low. It is therefore preferred that the difference in heat capacity in Jg⁻¹K⁻¹ at Tg is less than 0.40 and is preferably less than 0.38. The difference is preferably not more than 0.35 and most preferably not more than 0.33. In practice it normally is above 0.2 or 0.25. Tg is preferably quite low, e.g., below 800°, often below 750° C., and preferably in the range 500-700° C., often 550-650° C.

The difference in heat capacity can be determined, and Tg can be determined (for instance at a cooling rate of 10K/min), in accordance with Reviews in Minerology, Volume 32, Structure Dynamics and Properties of Silicate Melts by J. F. Stebbins et al, Chapter 1 pages 1-9 by Moynihan and Chapter 3 pages 72-75 by Richet et al. Examples of typical plots are in Thermochimica Acta, 280/281, (1996) 153-162 by Moynihan et al. Temperatures are measured by Differential Scanning Calorimetry.

Since the extrusion temperature may be above T_{liq}, and since increasing the spinning temperature significantly above typical E-glass values (up to around 1400° C.) can cause accelerated wear of the bushings, it is preferred that T_{liq} is below not more than 1380° C., preferably below 1350 or 1320° C., and generally below 1300° C. Values of below 1275° C. or, especially, 1250° C. are particularly preferred. Generally therefore T_{liq} is at least 1100° C. and usually above 1130° C. Often it is above 1170° C.

The extrusion temperature (i.e., the temperature of the melt as it is extruded through the extrusion orifices should not be too high or else it creates particular demands on the materials of which the orifices are formed. Usually the temperature is below 1500° C., preferably below 1450° C.

The viscosity of the melt preferably is not too high during extrusion as otherwise it may be difficult to achieve satisfactory extrusion and drawing. Accordingly the viscosity at T_{liq+50} and preferably at the temperature of extrusion should normally not be more than 10000 poise, preferably not more than 5000 poise and usually not more than 3000 poise. Often it is not more than 2000 poise.

In practice melt temperature may vary a little during the process. As explained, it should normally always be at least T_{liq+50} in order that there is no crystallisation and the viscosity is always below 10000 poise and preferably below 3000 poise.

The viscosity should never fall below 200 poise and is preferably in the range 300 to 1000, most preferably 400 to 800 (typically around 500 poise) at the highest temperature which is probable for the melt being extruded. This maximum temperature is usually at least 100° C. above T_{liq}, often in the range 120 to 200° C. above T_{liq}, typically around 150° C. above Tliq. Accordingly the lowest viscosity at the temperature of extrusion is usually above 200 poise and often above 500 poise. In practice therefore extrusion is generally conducted at a temperature whereby the viscosity is in the range, typically, 200 to 10000 poise, often 500 to 5000 poise.

In order to facilitate convenient operation of the furnace and to give some flexibility in the temperature control while still having a suitable viscosity during extrusion it is desirable that the temperature range between the highest and lowest convenient spinning viscosities is at least 50° C. and it can even be up to 100° C. It can be higher such as 120 or 150° C., or even 200° C. but this is generally unnecessary since control within, for instance, a range of around 70 or 80° C. is usually adequate. Thus, if the extremities of working viscosities are 5000 to 200 poise then the difference in temperatures for these values should be in the quoted range of 50 to 100° C. but if, as is more usual, the viscosity range is 2000 to 500 poise or even less, for instance 1500 to 600 poise, then the difference of from 50 to 100° C. should apply to this range of viscosities.

A typical combination of preferred values is
T_{liq} is 1200 to 1250° C.,
viscosity at T_{liq} is 900 (preferably above 1000 and often above 1100) up to 1500 or 2000 poise,
temperature for a viscosity of 900 poise or preferably 1000 poise, or more, is 0 to 70° C. preferably 5 to 50° C. above T_{liq},
T_{liq+50} and/or temperature for viscosity of 2000 poise is 1250 to 1300° C.,
and temperature for a viscosity of 200 poise (or preferably 500 poise) is 1340 to 1450° C., and the temperature difference between 5000 poise and 500 poise (or preferably between 2000 poise and 500 poise) is from 50 to 150° C.

When a curve is plotted of viscosity against temperature for the relevant materials, it is immediately apparent that a small increase in temperature gives a much larger reduction in viscosity at lower temperatures than at higher temperatures. The quoted limits take account of this and ensure that the working range of viscosities (generally 5000 to 500 poise) is spread over a usefully wide temperature range (typically 50 to 150° C.) and that the liquidus temperature is at an appropriate value such that the viscosity is appropriate for spinning at a temperature only 30 to 50° C. above T_{liq}.

The invention includes fibres which are continuous filaments formed of the various generic definitions of fibres, including each of class A, B, C, D and E fibres, and preferred glasses described above. The invention includes methods of making these continuous filaments by providing a homogeneous charge in a melter, melting this, flowing the melt through a forehearth into a bushing containing a plurality of extrusion orifices for the melt, and drawing filaments downwardly from the orifices and solidifying the filaments by cooling. The drawn filaments typically have a median diameter of above 5 μm and usually above 7 μm and usually around 9 μm, although it can be up to 25 μm or 50 μm or more.

The invention includes yarn formed from a bundle of these filaments alone, or with other filaments. The invention includes fabrics formed from such yarn or other filaments. The invention also includes the method of forming the fabrics.

The fibres of the invention can have mechanical properties similar to E glass fibres but with increased biosolubility, especially when determined in vitro at pH 4-5 or in vivo in the lung. They can have similar dielectric properties to E glass, especially when the fibres contain 2-10% B₂O₃.

The invention also includes cut fibres formed from such filaments (or from yarn containing such filaments), wherein the filaments are formed of the various generic and preferred compositions described above. These cut fibres have diameters as indicated above for filaments and they have lengths that are usually above 3 mm and preferably above 5 mm, for instance at least 10 mm typically up to 25 or 50 mm.

The invention also includes microfibres formed from the various generic (including classes A, B, C, D and E) and preferred compositions described above, and in particular formed by flame attenuation of continuous filaments formed from such compositions, by the general method described above. The microfibres generally have a length based median diameter of below 2.5 μm and usually below 2 μm. It should be noted that the diameter of microfibres is less than the diameter of conventional mineral wool, that is to say the wool formed from staple fibres formed by processes such as the spinning cup process or the Dusenblasten process. The staple fibres of glass wool normally have a length based median diameter of ≧3 μm, typically 3-3, 5 μm.

The processes for extruding the filaments to make the cut fibres and the microfibres are less sensitive to deviations from optimum melt properties, because it is not necessary to extrude and draw the filaments with the precision needed for optimum continuous filament manufacture. This is advantageous in the invention since the need for biosolubility in glass fibres made by extrusion and mechanical drawing is greatest when the drawn fibres are to be converted to cut fibres or mirofibres. Accordingly the necessary solubility can be achieved in such products from a melt having properties adequate for production of these fibres, without the need to optimise the melt properties to the standards required for normal E glass continuous filament production.

The invention also includes non-woven fabrics and other sheet materials, such as filter cloths, formed from the microfibres or from the cut fibres. The invention also includes fibre reinforced products wherein the fibre reinforcement is continuous filaments, cut fibres or microfibres in a polymeric or other matrix or wherein the fibres are bonded or woven together, and wherein the products are liable to be abraded in use (e.g., as brake linings) or cut in use, with the consequential risk of escape of glass dust or fibrils.

The invention also includes the use of the continuous filaments or other fibres as biosoluble fibres, and in particular the use of the fibres for applications where it is required to show that the fibres have biosolubility. The invention is of particular value when the fibres are microfibres. In particular, the invention includes the use of the fibres for an application where they are shown to be biosoluble (i.e., biodegradable in the lung). The invention also includes the use of a melt having the selected analysis and properties to form such fibres.

The invention also includes a package or other product containing the continuous filaments or other fibres and which is labelled or associated with advertising referring to the biosolubility of the fibres.

The invention also includes a method of making the continuous filaments or other fibres comprising selecting a composition having the required temperature viscosity relationship and having the required biosolubility (when present as fibres) and forming fibres from the composition. The selection may be conducted solely by theoretical identification of an appropriate composition based on previous experience or the selection may be made on the basis of examining the properties of various compositions and fibres made from them and selecting a composition having the required properties for the melt and the fibres.

Determination of Liquidus Temperature

This is determined in accordance with ASTMC-829-821 Method B.

Determination of Viscosity

All viscosities mentioned herein are determined by measurement as described at Table 1, No. 4, of DIN 53019 Part 2.

Determination of Temperature

All temperatures are determined by thermo-couple measured on the melt in the bushing, which in practice amounts to measuring the temperature while entering the bushing.

Biosolubility

This may be determined either directly on flame attenuated fibres or by comminuting filaments to a consistent small standard size and then applying the methods described above or the protocols described in Christensen, et al. “Effect of chemical composition of man-made vitreous fibres on the rate of dissolution in vitro at different pHs”. Environ. Health Perspect, 1994, 102(5), 83-86, or in Guldberg, et al. “Method for determining in vitro dissolution rates of man-made vitreous fibres”, Glastech. Ber. Glass Sci. Technol, 1995, 68, No6, p. 181-187.

Instead of using an in vitro test, in vivo tests known for assessing the biosolubility of man-made vitreous fibres may be used. Whatever test is used, preferably it determines the solubility at around pH 4.5 and, in particular, it preferably indicates solubility in the environment of macrophages in the lung.

Calculation of Amount of SiOSi Bridges

The chemical analysis of the glass guarantees that the predominant structure will be a tetrahedral structure formed by silicon and aluminium ions, and the amounts much be such that the calculated amount of SiOSi bridges is not more than 18% of the total oxygen bridges.

The chemical composition is known and is such as to guarantee that melt is what is often referred to as a peralkaline aluminosilicate glass wherein all the alumina ions are charge balanced by alkali metal or alkaline earth metal ions.

The calculation for fibres which are free of boron or contain less than 2% boron is based on the following assumptions:

Alumina is tetrahedrally coordinated and charge balanced.

The charge balancing of aluminium is made in accordance with Bottinga and Weill “The viscosity of Magmatic Silicate Liquids: A model for calculation” AM J Science, 272 (May 1972) pp 438-4.75, Hess “The role of high field strength cations in silicate melts” Advances in Physical. Geochemistry—Physical Chemistry of Magmas 9 (1991) Chapter 3, pp 152-185, or Mysen, “Structure and properties of silicate melts”, Elsevier Science Publishers (1988) Chapter 3, pp. 79-146 and chapter 8, p 266.

Alumina is placed in fully polymerised sites; all non-bridging oxygens are placed around silica and titanium ions.

The remaining network can be treated as tecto-aluminosilicate.

The calculation sequence is:
1. Calculation of distribution of charge balancing cations
2. Calculation of Q (degree of aluminium avoidance) based on charge balancing of aluminium
3. Allocation of non-bridging oxygens to silica and titanium
4. After allotting the non-bridging oxygens to silica, the remaining glass is treated as a tecto-aluminosilicate glass.

The chemical composition (mol %) is assumed known. Calculation of tetrahedral alumina-units is done according to the procedure described by Bottinga and Weill (X_{bw}).

Lee and Stebbins introduce the variable Q, which describes the degree of aluminium avoidance (avoidance of Al-Q-Al linkages). Q=0 for no avoidance and Q=1 for total avoidance. It is found that the Q value varies from approx. 0.85 when. ½Ca²⁺ is charge-balancing aluminium to approx. 0.99 when Na⁺ is the charge-balancing ion. The fraction of alkali and earth alkali balanced aluminium (R_Al) is calculated:

$$R\_Al = \frac{{NaAlO}_{2 ( bw )} + {KAlO}_{2 ( bw )}}{\begin{matrix}{NaAlO}_{2 ( bw )} + {KAlO}_{2 ( bw )} + \\ 2 \cdot ( {CaAl}_{2} {O}_{4 ( bw )} + {MgAl}_{2} {O}_{4 ( bw )} )\end{matrix}}$$

Q=R_Al.0.99+(1−R_Al).0.85
The NBO/T ratio (non-bridging oxygens (NBO) per tetrahedral coordinated cations (T)) is calculated from the molar composition (Xₘₒₗ):
NBO=2·(FeOₘₒₗ+CaOₘₒₗ+MgOₘₒₗ+Na₂Oₘₒₗ+K₂Oₘₒₗ—Al₂O₃₍ₘₒₗ₎)
T=SiO₂₍ₘₒₗ₎+TiO₂₍ₘₒₗ₎+2.Al₂O₃₍ₘₒₗ₎
As each tetrahedrally coordinated cation has four oxygen linkages, the fraction of non-bridging oxygen of the total number of oxygen linkages is:

$${N}_{Si \text{-} O \text{-} R} = \frac{NBO}{4 \cdot T}$$

This calculated fraction of oxygen bonds is allotted to silica and titanium as non-bridging. Those bonds are substracted the silica network and the remaining fully polymerised network is found as
Xₛᵢ=[(SiO_{2(bw)}+TiO_{2(bw)}−0.5(FeO_{(bw)}+CaO_{(bw)}+MeO_{(bw)}+Na₂O_{(bw)}+K₂O_{(bw)})]
X_{Al}=(KAlO_{2(bw)}+NaAlO_{2(bw)}+2(CaAl₂O_{4(bw)}+MgAl₂O_{4(bw)})]
The fraction of aluminium and silica (+titanium) in the network is then:

$${Si}_{network} = \frac{{X}_{Si}}{{X}_{Si} + {X}_{Al}} \qquad {Al}_{network} = \frac{{X}_{Al}}{{X}_{Si} + {X}_{Al}}$$

Based on NMR-measurements Lee and Stebbins, the degree of aluminium avoidance in aluminosilicated glasses. “Am Mineral” 84 (1999), pp 937-945, introduce the variables η, and β for the calculation of the distribution of linkages:
η\sqrt{1−Q}
β=\sqrt{1+4.Si_{network}.Al_{network}.(η²−1)}
By use of β, three types of oxygen linkages in fully polymerised melts are calculated as:

$$\begin{matrix}{X}_{Si \text{-} O \text{-} Al} = 4 \cdot {Si}_{network} \cdot {Al}_{network} \cdot \frac{1}{β + 1} \\ {X}_{Si \text{-} O \text{-} Si} = {Si}_{network} ( 1 - 2 \frac{{Al}_{network}}{β + 1} ) \\ {X}_{Al \text{-} O \text{-} Al} = {Al}_{network} ( 1 - 2 \frac{{Si}_{network}}{β + 1} )\end{matrix}$$

The total oxygen linkages distribution is found by normalising the network linkages by
(1-N_{Si—O—R})
N_{Si—O—Al}═X_{Si—O—Al}.(1-N_{Si—O—R})
N_{Si—O—Si}═X_{Si—O—Si}.(1-N_{Si—O—R})
N_{Al—O—Al}═X_{Al—O—Al}.(1-N_{Si—O—R})
N_{Si—O—R}═N_{Si—O—R}

The value is considered to be accurate to ±0.005 and so 0.17% (i.e., 17%) is indicated by a calculated value of above 0.165 to below 0.175.

After applying this calculation, the calculated value for SiOSi (N_{Si—O—Si}) should be 0.18 or less, namely 18% or less of the oxygen bridges are SiOSi bridges. Often the amount is below 17% and preferably below 15 or even 14%. Normally it is above 10% and often above 12%.

To make the fibres, a homogeneous charge is usually used to form the melt in the melter and this may be a charge of homogeneous marbles or other pellets previously formed in a prior melting operation and/or may be a blend of finely ground particulate materials which are melted in conventional manner with appropriate agitation, such as bubbling, to ensure a homogeneous melt. Typically the melter can be substantially the same as is conventional in the production of E-glass and as described by Loewenstein (but with modification of the bushings around the spinning orifices, if necessary, to provide adequate temperature and corrosion resistance). The melter will be designed according to whether it is melting raw materials or marbles, or a combination thereof. The depth of the melt in the melter can be, for instance 20 to 120 cm.

The charge is heated by gas and/or oil and/or electricity (usually gas or oil optionally with some electrical heating as a supplement) and not by solid carbon. The use of solid carbon (as is conventional in the production of mineral wool) is inappropriate. In particular, it is desirable that the conditions are not so reducing that any iron is present as metallic iron which destroys the bushing and may interfere with the filament formation. This is in contrast to conventional rock, stone and slag wool production where metallic iron in the melt is unwanted but acceptable.

The melt flows from the main melter through a region conventionally referred to as a forehearth into a bushing, all of which can be of conventional construction as described by Loewenstein. Likewise, the extrusion orifices and the drawing technique and the processes to which the filaments are subjected during drawing may be conventional, as described by Loewenstein. Naturally it is necessary to select the appropriate orifice sizes and the precise drawing, cooling and sizing or other conditions so as to obtain filaments having the desired diameter and physical properties such as tensile strength, elastic modulus and elongation at break.

The filaments are, as usual, extruded as a bundle of a large number of filaments, usually at least 50 and often more than 200 up to for instance 4000. Usually the filaments are twisted or bundled into multifilament yarn although they may be maintained as monofilaments, in conventional manner.

The filaments (as monofilaments or yarn) may, e.g., be used for purposes for which E-glass filaments are used at present. Examples include most common textiles, mufflers, exhaust systems.

They (as monofilments or yarn) may be cut or otherwise comminuted and used for any of the purposes for which cut E-glass filaments and yarn are used at present. Examples include composite materials.

Alternatively, the filaments may be extruded in a coarser form and the bundle, after solidification, may be subjected to flame attenuation so as to form microfibres which are collected on a collector as a web, for instance for use as filters.

Two examples of suitable compositions for use in the invention to make continuous filaments, cut fibres or microfibres are

| Composition | 1 | 2 |
|---|---|---|
| SiO₂ (wt %) | 46.4 | 43.0 |
| Al₂O₃ | 27.5 | 25.7 |
| TiO₂ | 0.0 | 0.0 |
| FeO | 0.0 | 0.0 |
| CaO | 14.7 | 18.8 |
| MgO | 2.8 | 5.0 |
| Na₂O | 7.6 | 6.3 |
| K₂O | 0.9 | 1.2 |
| SiOSi | 0.169 | 0.121 |

Composition 1 has a particularly low difference in heat capacity at Tg and gives fibres of good biosolubility and allows excellent spinning, but is spun at a relatively high temperature and viscosity. Composition 2 has lower viscosity and gives even better biosolubility.

Each of the compositions is formed into a melt, and then into fibres, using a laboratory version of a conventional E glass furnace, extrusion and mechanical drawing apparatus.

Other examples, with Tg, T_{liq}, and flow-through dissolution rate v (nm/day at 37° C. in Gambles liquid at pH 4.5, calculated on Si in solution) are

| | 3 Wt % | | | | |
|---|---|---|---|---|---|
| | 3 | 4 | 5 | 6 | E |
| SiO₂ | 46.5 | 44.6 | 42.8 | 41.5 | 52.2 |
| Al₂O₃ | 27.3 | 28.4 | 25.6 | 26.5 | 16.4 |
| TiO₂ | <0.1 | <0.1 | <0.1 | <0.1 | <0.1 |
| FeO | <0.1 | <0.1 | <0.1 | <0.1 | <0.1 |
| CaO | 14.9 | 15.2 | 18.7 | 18.9 | 18.9 |
| MgO | 2.8 | 3.0 | 5.0 | 5.1 | 5.0 |
| Na₂O | 7.2 | <0.1 | 6.3 | <0.1 | <0.1 |
| K₂O | 0.9 | <0.1 | 1.2 | <0.1 | <0.1 |
| P₂O₅ | <0.1 | <0.1 | <0.1 | <0.1 | <0.1 |
| B₂O₃ | <0.1 | 8.4 | <0.1 | 7.7 | 7.4 |
| Tg (° C.) | 709 | 728 | 696 | 702 | 688 |
| T_{liq} (° C.) | 1180 | 1231 | 1200 | 1230 | 1122 |
| V_{period}, day 1-4 | 37.9 | 17.3 | 59.3 | 60.6 | 0.0 |
| Vₛₜₐᵣₜ, day 14 | 45.8 | 23.1 | 60.2 | 67.6 | 1.1 |

The Si—O—Si values for compositions 3 and 5 are 0.17 and 0.12 respectively. The great improvement in bisolubility of fibres 3 to 6, relative to E glass, is clear.

Comparisons of resistance to strong acid, resistance to strong alkali, tensile strength, dielectric constant and electrical conductance of fibres 4 and E showed that fibre 4 is a fibre which is a satisfactory replacement for the normal uses of E glass but with the advantage of being biosoluble.

Other suitable fibres, additional to fibres 1 to 6 include a modification of fibre 4 wherein the amount of CaO is reduced to 13% and 2.2% BaO is added, and a modification of fibre 5 in which alkali is partly replaced by up to 2% of one or more of TiO₂, ZrO₂, BaO, ZnO and Li₂O.

1. Fibres of substantially colourless aluminosilicate glass wherein the fibres are selected from continuous filaments, cut fibres and microfibres, characterised in that the glass contains, by weight oxides,

| | |
|---|---|
| SiO₂ | 25-52% |
| Al₂O₃ | 20-35% |
| SiO₂ + Al₂O₃ | 60-80% |
| FeO | 0-1.5% |
| CaO | 5-30% |
| MgO | 0-20% |
| Na₂O + K₂O | 0-15% |
| TiO₂ | 0-5% |
| B₂O₃ | 2-10% |

2. Fibres according to claim 1 in which the glass contains, by weight oxides,

| | |
|---|---|
| SiO₂ | 43-52% |
| Al₂O₃ | 25-35% |
| SiO₂ + Al₂O₃ | 70-80% |
| FeO | 0-1.5% |
| CaO | 5-30% |
| MgO | 0-20% |
| Na₂O + K₂O | 0-15% |
| TiO₂ | 0-5% |
| B₂O₃ | 2-10% |

3. Fibres according to claim 1 in which the glass contains, by weight oxides,

| | |
|---|---|
| SiO₂ | 35-45% |
| Al₂O₃ | 20-30% |
| SiO₂ + Al₂O₃ | 60-75% |
| FeO | 0-1.5% |
| CaO | 5-30% |
| MgO | 0-20% |
| Na₂O + K₂O | 0-15% |
| TiO₂ | 0-5% |
| B₂O₃ | 2-10% |

4. Fibres according to claim 1 in which the glass contains, by weight oxides,

| | |
|---|---|
| SiO₂ | 30-40% |
| Al₂O₃ | 25-35% |
| SiO₂ + Al₂O₃ | 60-75% |
| FeO | 0-1.5% |
| CaO | 5-30% |
| MgO | 0-20% |
| Na₂O + K₂O | 0-15% |
| TiO₂ | 0-5% |
| B₂O₃ | 2-10% |

5. Fibres according to claim 1 in which the glass contains, by weight oxides,

| | |
|---|---|
| SiO₂ | 40-48% |
| Al₂O₃ | 23-30% |
| SiO₂ + Al₂O₃ | 65-78% |
| FeO | 0-1% |
| CaO | 10-20% |
| MgO | 2-10% |
| Na₂O + K₂O | 0-10% |
| TiO₂ | 0-3% |
| B₂O₃ | 2-10% |

6. Fibres according to claim 1 in which the amount of Na₂O+K₂O is not more than 2%.

7. Fibres according to claim 1 in which the glass contains one or more oxides selected from TiO₂, BaO, ZrO₂, ZnO and LiO₂ in a total amount of 2 to 10%.

8. Fibres according to claim 1 in which the viscosity at T_{liq} is at least 900 poise.

9. Fibres according to claim 1 in which the viscosity at T_{liq}+50 is not more than 10000 poise.

10. Fibres according to claim 1 in which the temperature for a viscosity of 500 poise is not more than 1450° C. and is more than 50° C. above the temperature for 5000 poise.

11. Fibres according to claim 1 in which T_{liq} is below 1320° C.

12. Fibres according to claim 1 in which the difference in heat capacity between the glass and the melt from which the glass is formed is not more than 0.35 Jg⁻¹K⁻¹.

13. Fibres according to claim 1 in the form of continuous filaments.

14. Fibres according to claim 1 in the form of chopped fibres obtained by chopping continuous filaments.

15. Fibres according to claim 1 in the form of microfibres obtained by flame attenuation of continuous filaments.

16. Fibres according to claim 1 in which the glass is a peralkaline glass.

17. A method of forming fibres according to claim 1 comprising forming a melt of the composition from a homogeneous charge in a melter heated by a gas or oil or electricity or combination thereof, flowing the melt through a forehearth into a bushing containing a plurality of extrusion orifices for the melt and drawing filaments downwardly from the orifices and collecting the filaments, and optionally converting the filaments into cut fibres or microfibres.

18-19. (canceled)

20. A package containing fibres according claim 1, and a label or other information referring to the biosolubility of the fibres.

21-34. (canceled)
